(19) United States
(12) Patent Application Publication
(10) Pub. No.: US 2025/0252403 A1
(43) Pub. Date: Aug. 7, 2025

(54) METHOD AND SYSTEM FOR ASSESSING VIRTUAL INTERACTION

(71) Applicant: Ashish Malhotra, Solon, OH (US)

(72) Inventors: Sahil Kaushik, Greater Noida West (IN); Nupur Malhotra, Solon, OH (US); Prakhar Dixit, Gondia (IN)

(73) Assignee: TIU Consulting LLC, Hudson, OH (US)

(21) Appl. No.: 18/432,338

(22) Filed: Feb. 5, 2024

(51) Int. Cl. G06Q 10/1053; G06N 3/08

(52) U.S. Cl. CPC G06Q 10/1053; G06N 3/08

(57) ABSTRACT

A system, method, and computer programmable product for assessing a virtual interaction is provided. The system is configured to retrieve assessment data, wherein the assessment data comprises at least one of: a plurality of assessment parameters, and a weightage score associated with each of the plurality of assessment parameters. The system is further configured to retrieve response data of a candidate associated with the assessment data. The system is configured to generate, using a trained AI model, a score for the response data based on the assessment data. Further, the system is configured to obtain user input based at least on the score of the response data and update the weightage score associated with at least one of the plurality of assessment parameters based on the user input, wherein the AI model is re-trained based on the updated weightage score.

### TECHNOLOGICAL FIELD

The present disclosure generally relates to platforms for recruitment, and more particularly relates to systems and methods for assessing candidates through virtual interaction.

### BACKGROUND

Conventionally, interviews involve a face-to-face conversation between a candidate and an interviewer to gather insights regarding skills (such as technical or communication skills) of the candidate. However, with the rapid advancements in telecom technology, telephone interviews and video conferencing have become a highly effective and efficient means of communication.

During video interviews, the candidate may or may not interact with a live interviewer. For example, a set of questions may be presented virtually to the candidate on a user device (such as, a smartphone, a computer, a tablet, and the like). Thereafter, the candidate may respond to the said questions verbally within a given time interval. However, such video interviews may not provide an accurate assessment of the skills of the candidate, thereby leading to problems such as poor collaboration, communication issues, mismatched cultural fit, and inadequate customer service. Thus, there exists a need to provide a comprehensive assessment process that evaluates the skills of the candidates in an efficient manner, thereby optimizing the process to assess the candidate through video interviews.

### BRIEF SUMMARY

A system, a method, and a computer-programmable product are provided herein to assess skills of candidate through virtual interaction using an AI model.

In one aspect, a system to assess skills of candidate through virtual interaction using an AI model is disclosed. The system may include one or more processors coupled to a memory, the memory having stored therein instructions executable by the one or more processors (hereinafter referred as a processor) to configure the system to retrieve assessment data, wherein the assessment data comprises at least one of: a plurality of assessment parameters, and a weightage score associated with each of the plurality of assessment parameters. The system is further configured to retrieve response data of a candidate associated with the assessment data. Thereafter, the system is configured to generate, using a trained AI model, a score for the response data based on the assessment data. Further, the system is configured to obtain user input based at least on the score of the response data; and update the weightage score associated with at least one of the plurality of assessment parameters based on the user input, wherein the AI model is re-trained based on the updated weightage score.

According to additional system embodiments, the assessment data further comprises one or more questions and corresponding one or more response features associated with each of the plurality of assessment parameters.

According to additional system embodiments, the response data comprises one or more response segments corresponding to one or more questions, and wherein one or more response features comprises positive response features and negative response features for the corresponding one or more questions.

According to additional system embodiments, the processor is configured to analyze, using the trained AI model, each of the one or more response segments based on the corresponding response features, generate, using the trained AI model, a segment score for each of the one or more response segments based on the analysis; and generate, using the trained AI model, the score for the response data based on the segment score for each of the one or more response segments.

According to additional system embodiments, wherein the AI model is trained based on the retrieved assessment data.

According to additional system embodiments, the processor is configured to retrieve a resume of the candidate, analyze, using the trained AI model, the resume of the candidate to generate an initial score; and shortlist the candidate for the virtual interaction based on the initial score.

According to additional system embodiments, the processor is further configured to add the candidate to a list of shortlisted candidates based on the score of the response data and the initial score.

According to additional system embodiments, the processor is further configured to obtain the user input based on the list of the shortlisted candidates and the resume of the candidate.

According to additional system embodiments, the response data further comprises at least one of: user input data, video data, or audio data.

In another aspect, a method for assessing skills of candidate through virtual interaction using an AI model is disclosed. The method comprises retrieving assessment data, wherein the assessment data comprises at least one of: a plurality of assessment parameters, and a weightage score associated with each of the plurality of assessment parameters. The method further comprises retrieving response data of a candidate associated with the assessment data. Further, the method comprises generating, using a trained AI model, a score for the response data based on the assessment data. Thereafter, the method comprises obtaining user input based at least on the score of the response data; and updating the weightage score associated with at least one of the plurality of assessment parameters based on the user input, wherein the AI model is re-trained based on the updated weightage score.

In yet another aspect, a computer program product for assessing skills of candidate through virtual interaction is disclosed. The computer program product a non-transitory computer readable medium having stored thereon computer executable instructions, which when executed by one or more processors, cause the one or more processors to conduct operations. The operation comprises retrieving assessment data, wherein the assessment data comprises at least one of: a plurality of assessment parameters, and a weightage score associated with each of the plurality of assessment parameters. The operation further comprises retrieving response data of a candidate associated with the assessment data. Further, the operation comprises generating, using a trained AI model, a score for the response data based on the assessment data. Thereafter, the operation comprises obtaining user input based at least on the score of the response data; and updating the weightage score associated with at least one of the plurality of assessment parameters based on the user input, wherein the AI model is re-trained based on the updated weightage score.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a block diagram of a network environment within which a system is implemented, in accordance with an embodiment of the present disclosure;

FIG. 2A illustrates an exemplary block diagram of the system, in accordance with an embodiment of the present disclosure;

FIG. 2B illustrates a user interface for receiving user input, in accordance with an embodiment of the present disclosure;

FIG. 2C illustrates a user interface for displaying an interactive web page, in accordance with an embodiment of the present disclosure;

FIG. 3A illustrates an exemplary first set of operations performed by the system, in accordance with an embodiment of the present disclosure;

FIG. 3B illustrates an exemplary a second set of operations performed by the system, in accordance with an embodiment of the present disclosure;

FIG. 4 illustrates an exemplary flowchart for an automated assessment of the candidate, in accordance with an embodiment of the present disclosure; and

FIG. 5 illustrates a flowchart for implementation of a method for assessing skills of candidate through virtual interaction, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

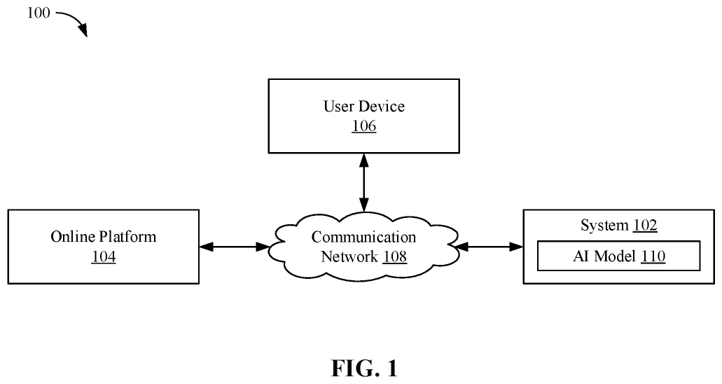

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 5, a brief description concerning the various components of the present disclosure will now be briefly discussed. Reference will be made to the figures showing various embodiments of a system for automated assessment of the candidate.

FIG. 1 illustrates a block diagram of a network environment within which a system is implemented, in accordance with an embodiment of the present disclosure. The network environment 100 comprises an online platform 104 that may provide certain services. Further, a user may access the services provided by the online platform 104 using a user device 106. For example, the online platform 104 may be associated with a recruitment platform, a social media platform, an education platform, a business or corporate website, and so forth.

Typically, the user may create a user account on the online platform 104 to access the services of the online platform 104. For example, the user, such as a candidate, may build a profile or upload a resume on the online platform 104 to initiate a job search. In such an example, the user may build, using the user device 106, a profile using an interactive web form available on the online platform 104. The interactive web form may require information, such as, but not limited to, personal details, educational background, professional experience, skills, achievements, and the like to build a user profile. The user device 106 may include, but is not limited to, a smartphone, a computer, a tablet, and the like.

The system 102 may include suitable logic, circuitry, interfaces, and/or code that may be configured to assess skills of a candidate through a virtual interaction. The skills of the candidate may include but is not limited to technical skills or non-technical skills associated with a given job post. In an example, the technical skills may refer to proficiency to perform given tasks or use particular tools within a given field of jobs or industry, such as but not limited to, programming skills, data analysis, digital marketing, project management, graphic design, network administration, engineering, cybersecurity, and the like. In another example, the non-technical skills may refer to as soft skills such as, but not limited to communication skills, collaboration, time management, problem solving, leadership, creativity, adaptability, emotional skills, negation skills, customer service, and the like.

The system 102 may be configured to retrieve assessment data. The assessment data may comprise at least one of: a plurality of assessment parameters, and a weightage score associated with each of the plurality of assessment parameters. The system 102 is further configured to retrieve response data of a candidate associated with the assessment data. Thereafter, the system 102 is configured to generate, using a trained AI model 110, a score for the response data based on the assessment data. Further, the system 102 is configured to obtain user input based at least on the score of the response data; and update the weightage score associated with at least one of the plurality of assessment parameters based on the user input, wherein the AI model 110 is re-trained based on the updated weightage score.

The system 102 may be communicatively coupled to the online platform 104, the user device 106, or any other device, via a communication network 108. The communication network 108 may be wired, wireless, or any combination of wired and wireless communication networks, such as cellular, Wi-Fi, internet, local area networks, or the like. In some embodiments, the communication network 108 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

All the components in the network environment 100 may be coupled directly or indirectly to the communication network 108. The components described in the network environment 100 may be further broken down into more than one component and/or combined together in any suitable arrangement. Further, one or more components may be rearranged, changed, added, and/or removed.

While hiring a candidate for an organization, a shortlisting process needs to be focused on various criteria outlined in a job description. The first step of the shortlisting process includes a thorough review of resumes of the candidates based on predefined criteria such as education, experience, and skills outlined in the job description. Such a screening is generally done by a professional and helps to narrow down the pool of candidates to those who fit the job description. Thereafter, the skills of the candidates may be evaluated, in the further recruitment process, to make informed hiring decisions and prioritize candidates who possess both technical expertise and strong non-technical skills. In general, assessment methods may involve human judgement, thereby introducing bias in an interviewer's evaluation of the candidate. Additionally, telephone interviews and video conferences may not help the interviewer to accurately gauge the skills of candidates, thereby contributing to challenges such as poor collaboration, communication issues, mismatched cultural fit, and inadequate customer service.

To overcome these challenges, the present disclosure provides a comprehensive method and system associated with an automated assessment process that evaluates the skills of the candidates in an efficient manner. The disclosed system 102 may be configured to generate, using a trained AI model 110, an aggregated score for assessing skills of candidates, thereby providing optimum candidate shortlisting, and mitigating bias.

Additional, fewer, or different components may be provided in the network environment 100. For example, a server, a router, a switch or intelligent switch, a database, additional computers or workstations, administrative components, such as an administrative workstation, a gateway device, a backbone, ports, network connections, and network interfaces may be provided. While the components in FIG. 1 are shown as separate from one another, one or more of these components may be combined. In this regard, a processor of the system 102 may be communicatively coupled to the components shown in FIG. 1 to carry out the desired operations and wherever required modifications may be possible within the scope of the present disclosure.

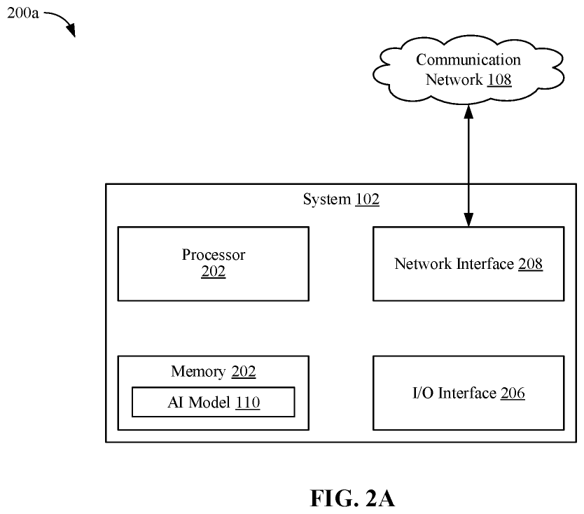

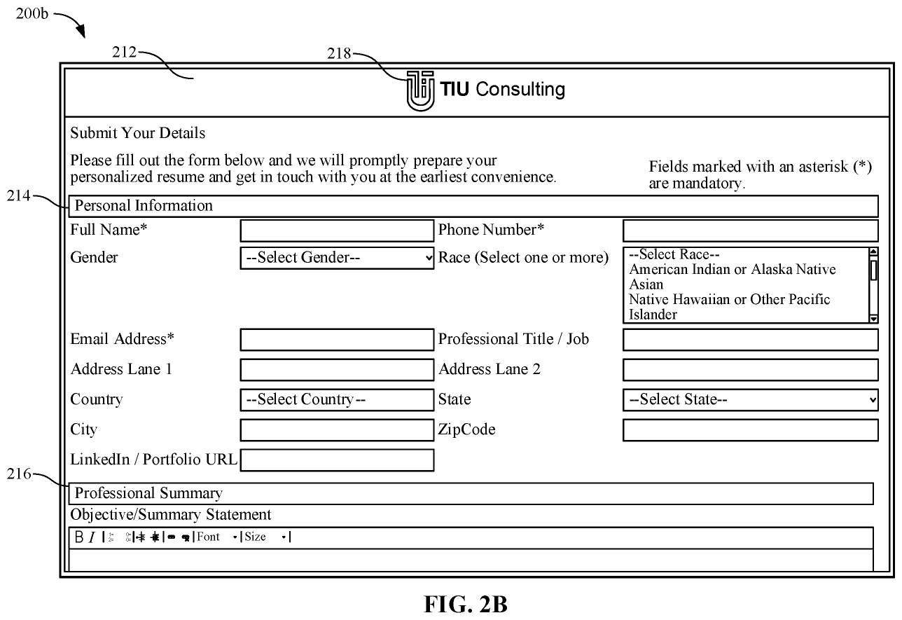

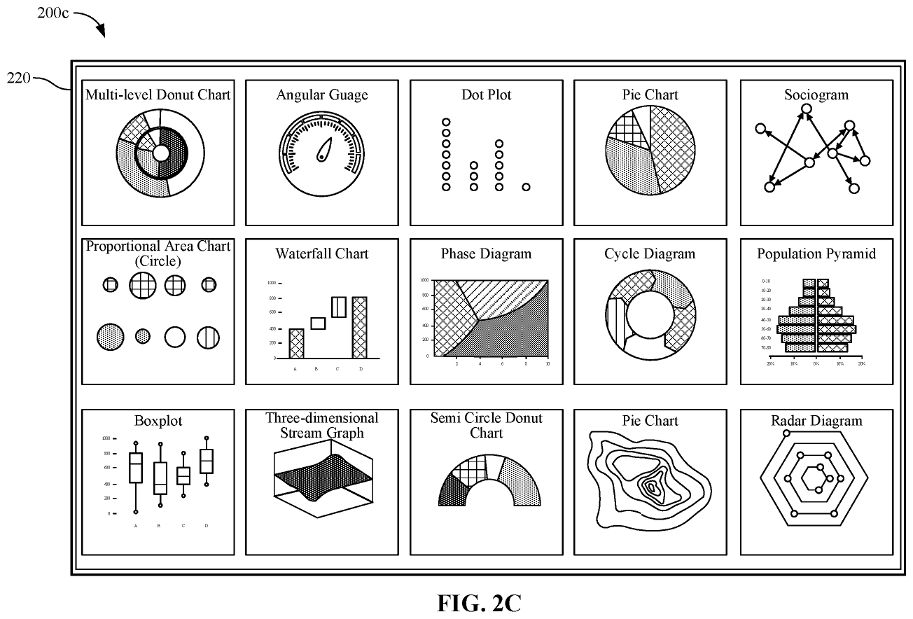

FIG. 2A illustrates an exemplary block diagram of the system, in accordance with an embodiment of the present disclosure. FIG. 2A is explained in conjunction with FIG. 1. The system 102 may include at least one processor 202, a memory 204, and an Input/Output (I/O) interface 206, a network interface 208. The at least one processor 202 may be communicatively coupled to the memory 204, the I/O interface 206, the network interface 208, and the AI model 110.

The processor 202 may include suitable logic, circuitry, and/or interfaces that may be configured to execute program instructions associated with different operations to be executed by the system 102. The processor 202 may include one or more specialized processing units, which may be implemented as an integrated processor or a cluster of processors that perform the functions of the one or more specialized processing units collectively. The processor 202 may be implemented based on a number of processor technologies known in the art. Examples of implementations of the processor 202 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 204 may include suitable logic, circuitry, and/or interfaces that may be configured to store program instructions to be executed by the processor 202. The memory 204 may be further configured to store a plurality of processor-executable instructions to be executed by the system 102. The memory 204 may be further configured to store the assessment data, response data, and resume data. Examples of implementations of the memory 204 may include, but is not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The input/output (I/O) interface 206 may include suitable logic, circuitry, interfaces, and/or code that may be configured to receive an input and provide an output based on the received input. The I/O interface 206 may include various input and output devices, which may be configured to communicate with the processor 202. For example, the system 102 may receive the assessment data via the I/O interface 206. The I/O interface 206 may include various input and output devices, which may be configured to communicate with different operational components of the system 102. Examples of the I/O interfaces 206 may include, but is not limited to, a touch screen, a keyboard, a mouse, a joystick, a microphone, and a display device (such as the display device 110).

The network interface 208 may include suitable logic, circuitry, interfaces, and/or code that may be configured to establish communication between the system 102, the online platform 104, and the user device 110, via the communication network 106. The network interface 208 may be configured to implement known technologies to support wired or wireless communication. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 208 may be configured to communicate via offline and online wireless communication with networks, such as the Internet, an Intranet, and/or a wireless network, such as a cellular telephone network, a wireless local area network (WLAN), a personal area network (PAN), and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), LTE, time division multiple access (TDMA), Bluetooth, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VoIP), Wi-MAX, Internet-of-Things (IoT) technology, Machine-Type-Communication (MTC) technology, a protocol for email, instant messaging, and/or Short Message Service (SMS).

The AI model 110 may be a neural network. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on a training dataset. Each node of the neural network may correspond to a mathematical function (e.g., a sigmoid function or a rectified linear unit) with a set of parameters, tunable during training of the neural network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different same mathematical function.

In training of the neural network, one or more parameters of each node of the neural network may be updated based on whether an output of the final layer for a given input (from a training dataset) matches a correct result based on a loss function for the neural network. The above process may be repeated for the same or a different input until a minimum loss function may be achieved, and a training error may be minimized. Several methods for training are known in art, for example, gradient descent, stochastic gradient descent, batch gradient descent, gradient boost, meta-heuristics, and the like.

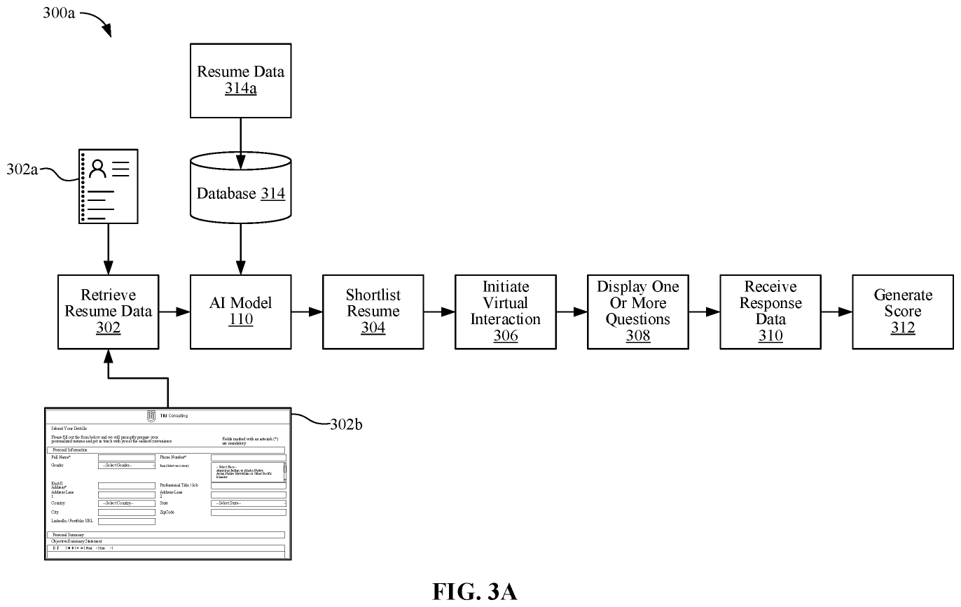

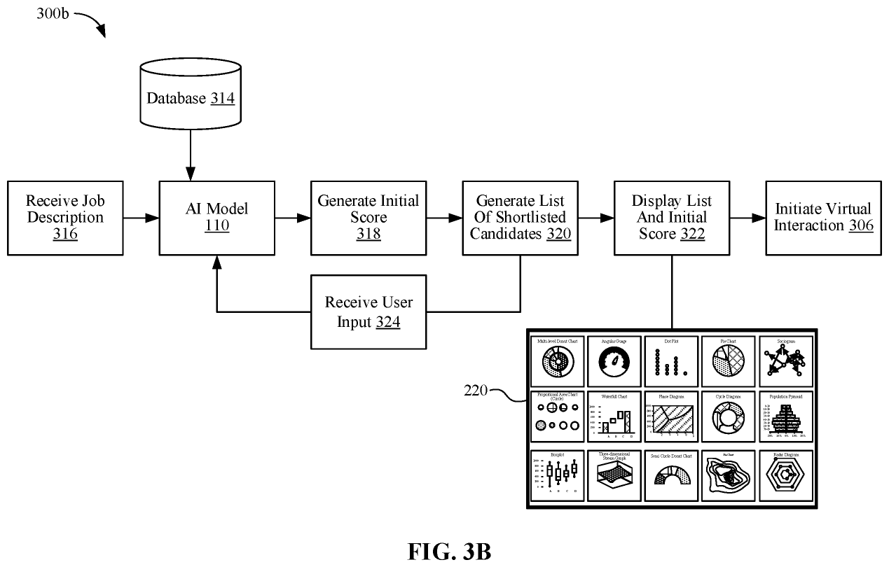

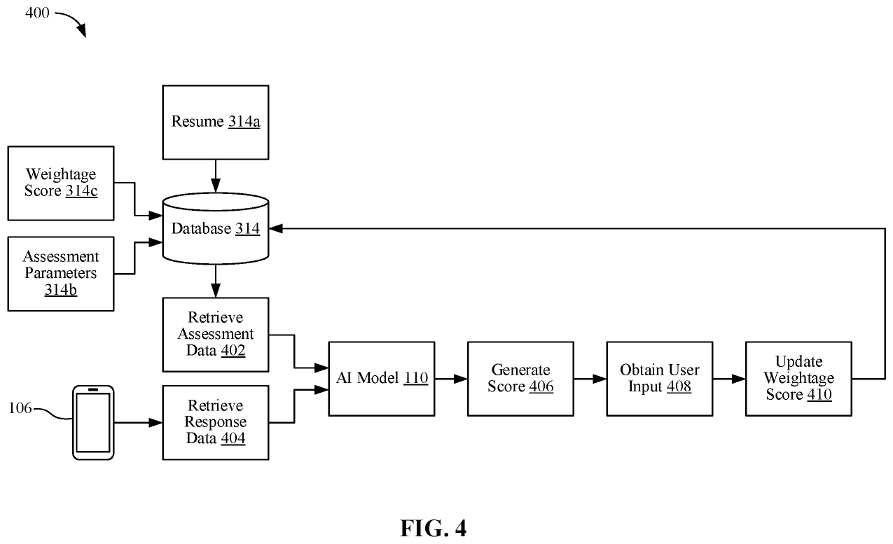

The neural network may include electronic data, such as, for example, a software program, code of the software program, libraries, applications, scripts, or other logic or instructions for execution by a processing device, such as circuitry. The neural network may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software. Although in FIG. 2A, the neural network is shown integrated within the system 102, the disclosure is not so limited. Accordingly, in some embodiments, the neural network may be a separate entity in the system 102, without deviation from scope of the disclosure. Details about the AI model 110 are provided, for example, in FIG. 3 and FIG. 4.

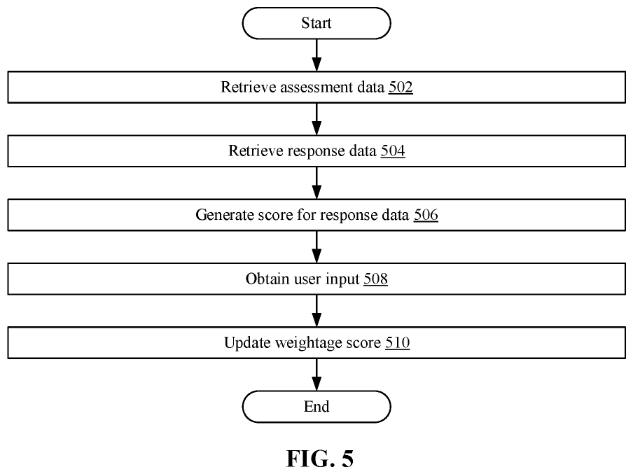

The functions or operations executed by the system 102, as described in FIG. 1, may be performed by the processor 202. Operations executed by the processor 202 are described in detail, for example, in FIG. 3, FIG. 4, and FIG. 5.

FIG. 2B illustrates a user interface 200b for displaying an interactive web page 212, in accordance with an embodiment of the present disclosure. The web page 212 includes a personal information option 214, and a professional summary option 216. The personal information option 214 may be configured to receive a user input indicative of a personal information of a candidate. For example, the personal information of the candidate may include, but not limited to, name of the candidate, contact information of the candidate, gender, and the like. The contact information of the candidate may further include data associated with, but not limited to, a phone number of the candidate, an address of the candidate, city, zip code, an email address, a social media profile and the like. The professional summary option 216 may be configured to receive a user input indicative of a professional experience of the candidate. The professional experience of the candidate may include, but not limited to education qualification of the candidate, work experience of the candidate, and skills of the candidate. Further, the web page 212 may be configured to display the logo 218.

In an example, the user input may comprise but not limited to a text input, a dropdown menu, slider options, and the like. In another example, the user may trigger action by clicking buttons like “Save”, “Submit” or “Cancel”. As shown in the FIG. 2B, the user may provide input through text fields such as entering full name, phone number, email address, job, address, LinkedIn profile, zip code, and professional summary. The user may further provide user input through dropdown menus such as selecting gender, race, country, and state from a predefined options.

Further, the system 102 may be configured to receive the user input from the web page 212. Based on the received user input, the system 102 may be configured to build a profile for the candidate.

FIG. 2C illustrates a user interface 200c for displaying an interactive web page 220, in accordance with an embodiment of the present disclosure. The webpage 220 may include a plurality of chart options associated with the skills of the candidate. As shown in the FIG. 2C the skills of the candidate may be displayed as, but not limited to, a sunburst chart, a pie chart, a line chart, a bar chart, a histogram, a scatter plot, a radar chart, and the like.

Further, the system 102 may be configured to display the skills of the candidate on the online platform 104, thereby employing a visual representation of the score of the candidate to identify patterns or trends at a glance. Such visual representation may facilitate a user (such as hiring professional) to make informed hiring decision and prioritize candidates who possess both technical expertise and strong non-technical skills.

FIG. 3A illustrates an exemplary first set of operations performed by the system, in accordance with an embodiment of the present disclosure. FIG. 3A is explained in conjunction with elements from FIG. 1, FIG. 2A, FIG. 2B and FIG. 2C. With reference to FIG. 3A, there is shown a block diagram 300a that illustrates exemplary operations from 302 to 312, as described herein. The exemplary operations illustrated in block diagram 300a may start at 302 and may be performed by any computing system, apparatus, or device, such as by the system 102 of FIG. 1 or the processor 202 of FIG. 2A. Although illustrated with discrete blocks, the exemplary operations associated with one or more blocks of the block diagram 300a may be divided into additional blocks, combined into fewer blocks, or eliminated, depending on the particular implementation.

At 302, resume data may be retrieved. In an embodiment, the system 102 may be configured to retrieve resume data 314a from the database 314 (such as memory 204). The resume data 314a may comprise a plurality of resumes associated with one or more candidates. In an example, the database 314 may be configured to store the resume data 314a of the candidates.

In operation, a user, such as a candidate, may upload a resume 302a or build a profile 302b on the online platform 104 to initiate a job search. In such an example, the candidate may build, using the interactive web page (as described in FIG. 2B), a profile on the online platform 104 to initiate the job search. In an example, the resume of the candidate may include information, such as, but not limited to, personal details, educational background, professional experience, skills, achievements, and the like.

At 304, a resume may be shortlisted. In an embodiment, the system 102 may be configured to shortlist, using the AI model 110, the resume of the candidate. In operation, the system 102 may be configured to retrieve a given job description, as described in FIG. 3B. The system 102 may be further configured to analyze, using the AI model 110, the job description to generate assessment data. The assessment data comprises at least one of: a plurality of assessment parameters, and a weightage score 314c associated with each of the plurality of assessment parameters, as described in FIG. 3B. Thereafter, the system 102 may be configured to analyze, using the AI model, the resume 302a of the candidate based on the assessment data.

The AI model 110 may be trained on identifying key words from the resume 302a and match the key words with the retrieved assessment data. Thereafter, the AI model 110 may generate an initial score for the resume 302a of the candidate. In an example, if the given job description includes requirements for “Python programming,” the AI model 110 will scan the resume data 314a from the database 314 to detect for the presence of the keyword “Python” in the resumes skills section. In another example, if the given job description includes requirements for “Data Analyst” role the AI model 110 may scan the resume data 314a to detect for the presence of the keyword like, but not limited to “data analysis,” and “data visualization.”

In operation, the system 102 may be configured to provide, as an input, the resume data 314a and the assessment data to the AI model 110. The AI model 110 may be pre-trained using the assessment data. In an example, the system 102 may employ the AI model 110 to match the skills and keywords mentioned in the job description with those found in the candidate's profile or resume. The AI model 110 may employ Natural Language Processing (NLP) techniques and machine learning models, like, but not limited to Keyword matching, Term Frequency-Inverse Document Frequency (TF-IDF), and Word Embedding, to identify relevant resumes of the candidates based on the job description. Additionally, the system 102 may employ the AI model 110 to evaluate the importance of words in the resume and determine an initial score in terms of context of the job description, as described in FIG. 3B.

The use of trained AI model 110 is effective in handling large volumes of data associated with the pool of candidates and optimizing the shortlisting process. Additionally, the system 102 leverages the use of trained AI model 110 to analyze the skills of the candidates, minimize biases and ensure its alignment with evolving job requirements.

At 306, a virtual interaction may be initiated. In an embodiment, the system 102 may be configured to initiate the virtual interaction for the candidate. In an example, if the initial score for the resume of the candidate is above a threshold value, then the resume may be shortlisted. Thereafter, the system 102 may be configured to add the resume of the candidate to the list of shortlisted candidates and initiate the virtual interaction. On the contrary, if the initial score for the resume of the candidate is below the threshold value, then the resume may not be shortlisted. Thereafter, the system 102 may be configured to display a message on the candidate profile indicating that the resume is not shortlisted. In an operation, the system 102 may employ the virtual interaction to assess the skills of the candidate from the list of shortlisted candidates. The virtual interaction may refer to virtual interview that takes place on the online platform 104.

At 308, one or more questions may be displayed. Once the virtual interaction is initiated for the shortlisted candidates, the system 102 may be configured to display the one or more questions on the web page to assess the skills of the candidate. In an example, the system 102 may be configured to retrieve a set of questions corresponding to the given job description. The AI model 110 may be configured to retrieve the set of questions from the database 314 based on the job description. In an example, each question may comprise a score associated therewith. During the virtual interaction, the one or more questions associated may be displayed using the user device 106, for example, but not limited to smartphone, computer, tablet, and the like. The user device 106 may have internal built in sensors, or communicatively coupled to one or more sensors (such as, but not limited to cameras and microphones) to receive the response data (such as the video data, and the audio data). In an example, the virtual interaction may include various question formats such as but not limited to open-ended questions, multiple-choice questions, scenario-based questions, and the like. Additionally, a virtual interviewer such as a chat bot, or an avatar may be employed to mimic interaction in a formal (such as office) or an informal (such as coffee shop) situation, thereby assessing interpersonal skills of the candidate.

At 310, response data may be received. In an embodiment, the system 102 may be configured to retrieve the response data of a candidate associated with the one or more questions. In an example, the system 102 may be configured to retrieve the response data using the user device 106. The database 314 may be further configured to store the response data. In an embodiment, the response data may comprise at least one of: user input data, video data, or audio data. For example, the response data to a multiple-choice question may be a user input indicative of a choice of from a given set of options. In another example, the response data for an open-ended question may be detailed or descriptive answer that may be in text data or audio data. In yet another example, the response data for a scenario-based question may be video data such as a video recorded answer.

At 312, a score may be generated. In an embodiment, the system 102 may be configured to generate, using the AI model 110, the score to assess the skills of the candidate based on the response data, as described in FIG. 4. In an example, if the score of the candidate is above a threshold value, then the candidate may be considered suitable for hiring. On the contrary, if the score of the candidate is below the threshold value, then the candidate may not be considered suitable for hiring.

FIG. 3B illustrates an exemplary a second set of operations performed by the system, in accordance with an embodiment of the present disclosure. FIG. 3B is explained in conjunction with elements from FIG. 1, FIG. 2A, FIG. 2B, FIG. 2C, and FIG. 3A. With reference to FIG. 3B, there is shown a block diagram 300b that illustrates exemplary operations from 316 to 324, as described herein. The exemplary operations illustrated in block diagram 300b may start at 316 and may be performed by any computing system, apparatus, or device, such as by the system 102 of FIG. 1 or the processor 202 of FIG. 2A. Although illustrated with discrete blocks, the exemplary operations associated with one or more blocks of the block diagram 300b may be divided into additional blocks, combined into fewer blocks, or eliminated, depending on the particular implementation.

At 316, a job description may be received. In an embodiment, the system 102 may be configured to receive the job description for which hiring is to be done. In an example, the system 102 may be configured to retrieve the job description from the database 314. In another example, the system 102 may be configured to receive user request indicative of an initiation for a job description, and retrieve information associated with a description for the given job description. In operation, a user, such as a hiring professional, may build a profile on the online platform 104 to initiate a candidate search for a given job description. In an example, an organization or a manager may provide the job description comprising of a plurality of job requirements for a given job post. The plurality of job requirements may include, but not limited education, experience, and skills.

At 318, an initial score may be generated. In an embodiment, the system 102 may be configured to generate the initial score for the resume of the candidate. The initial score refers to a score for the resume of the candidate. The AI mode 110 may be configured to generate the initial score based on the given job description. In an example, if a job requires “Python programming,” the system 102 will scan, using the AI model 110, the resume from the database 314 to detect for the presence of the keyword “Python” in the candidate's skills section. Additionally, the system 102 may employ the AI model to evaluate the importance of words in the resume and determine the initial score in terms of context of the job requirements. In an example, if the candidate's resume includes many relevant keywords and their TF-IDF score is high, the AI model 110 will generate a high score for the resume. On the contrary, if the candidate's resume does not include relevant keywords and their TF-IDF score is low, the AI model 110 will generate a low score for the resume.

At 320, a list may be generated. In an embodiment, the system 102 may be configured to generate a list of shortlisted candidates. In operation, if the initial score for the resume of the candidate is above a threshold value, then the resume may be shortlisted. On the contrary, if the initial score for the resume of the candidate is below the threshold value, then the resume may not be shortlisted, as explained in FIG. 3.

At 322, output may be displayed. In an embodiment, the system 102 may be configured to display the list of shortlisted candidates and the initial score, as described in FIG. 2C. In an example, the system 102 may be configured to display score of the shortlisted candidates and resume of the candidates on the user interface for easy access. Such visual representation may be helpful for the hiring manager or professional to determine whether or not a deserving candidate is assessed incorrectly due to the assigned initial score. To remove such inconsistencies, the system 102 may receive the user input to update the score associated with the resume of the candidate.

At 324, user input may be received. In an embodiment, the system 102 may be configured to obtain the user input. For example, the hiring manager or a professional may analyze the initial score of the shortlisted candidates, and resume of the candidates, thereby deciding inconsistency between the generated scores. In such an example, the hiring manager may provide a feedback using the user input to identify areas where the AI model 110 might have misjudged candidates. In an example, the system 102 may receive feedback on candidates who were shortlisted and rejected based on the generated initial score. The system 102 may be configured to retrain the AI model 110 based on the received feedback, thereby optimizing the assessment process to evaluate the skills of the candidates in an efficient manner.

Thereafter, the system 102 may be configured to initiate the virtual interaction for the shortlisted candidates to assess the skills of the candidate.

FIG. 4 illustrates an exemplary flowchart for an automated assessment of the candidate, in accordance with an embodiment of the present disclosure. FIG. 4 is explained in conjunction with elements from FIG. 1, FIG. 2A, FIG. 2B, FIG. 2C, FIG. 3A, and FIG. 3B. With reference to FIG. 4, there is shown a block diagram 400 that illustrates exemplary operations from 402 to 410, as described herein. The exemplary operations illustrated in block diagram 400 may start at 402 and may be performed by any computing system, apparatus, or device, such as by the system 102 of FIG. 1 or the processor 202 of FIG. 2A. Although illustrated with discrete blocks, the exemplary operations associated with one or more blocks of the block diagram 300b may be divided into additional blocks, combined into fewer blocks, or eliminated, depending on the particular implementation.

At 402 assessment data may be retrieved. In an embodiment, the system 102 may be configured to retrieve the assessment data from the database 314 associated with the system 102. In an example, the database 314 may be configured to store the assessment data comprises at least one of: a plurality of assessment parameters 314b, and a weightage score 314c associated with each of the plurality of assessment parameters 314b. The assessment data may refer to the job description for a given job post. In an example, the plurality of assessment parameters 314b may include, but is not limited to one or more technical skills or non-technical skills associated with the given job description. In another example, the weightage score 314c may refer to a skill score associated with each of the plurality of assessment parameters 314b, such that each assessment parameter may have a given skill score associated therewith based on the job description.

In an example, the system 102 may be configured to receive such user request indicative of an initiation for a job description, and retrieve information associated with a description for the given job description, as described in FIG. 3B. For example, to hire a programming expert, the job description may include technical skills such as web development, programming language and the like. For such a job description, the assessment parameters 314b may include, but not limited to C++, Java, python programming, web designing, problem solving, time management, team collaboration, and the like. Further, the weightage score 314c associated with each of the plurality of assessment parameters 314b will be retrieved from the database. For such a job description, a weightage score 314c associated with the technical skills may be higher than a weightage score 314c associated with the non-technical skills associated with therewith. In an example, the system 102 may be configured to receive user input indicative of the weightage score 314c associated with each of the plurality of assessment parameters 314b.

In an embodiment, the AI model 110 may be trained based on the retrieved assessment data. Additionally, the AI model 110 may be configured to analyze the resume of the candidate based on the retrieved assessment data and generate the initial score. In an example, the AI model 110 may be trained on identifying key words from the resume and match the key words with the retrieved assessment data. Thereafter, the AI model 110 may generate the initial score for the resume of the candidate and shortlist the candidate for the virtual interaction, as described in FIG. 3B.

For example, if a job requirement is for a “Data Analyst” role with assessment parameters 314b like “data analysis,” “Python programming,” and “data visualization.”, a candidate's resume may include terms like “data analytics” and “Python programming.” In such an example, the AI model 110 may be trained to generate an initial score for the resume based on the matches. For example, using keyword matching the generated initial score may be 2 out of 3 for keywords (Python programming) matched in the resume. In another example, using TF-IDF matching, the generated initial score may be high for keywords like “Python” and “data”. In yet another example, using word embeddings the generated initial score may correspond to high similarity between “data analysis” and “data analytics.” Thereafter, the AI model 110 combines the said scores to generate the initial score for the resume of the candidate. As a result, if the candidate's resume contains many relevant keywords and their TF-IDF score is high, they will receive a higher score. Thereafter, the system 102 may be configured to shortlist the resume of the candidate.

In an embodiment, the system 102 may be configured to generate the list of the shortlisted candidates and initiate the virtual interaction to further evaluate both technical and non-technical skills, as described in FIG. 3A. Therefore, making informed hiring decisions and prioritizing candidates who possess both technical expertise and strong non-technical skills.

In an embodiment, the assessment data may further include one or more questions and corresponding one or more response features associated with each of the plurality of assessment parameters 314b. The one or more questions may refer to the set of questions displayed in the virtual interaction to assess the skill of the candidates associated with the job description.

The one or more response features may comprise positive response features and negative response features for the corresponding one or more questions. In an example, the one or more response features may refer to a list of key terms or phrases relevant to the one or more questions. Such key terms or phrases may include positive key terms or phrases (such as positive response features) and negative key terms or phrases (such as negative response features). In an embodiment, the trained AI model 110 may analyze each of the one or more response features to identify the positive response features and negative response features for the corresponding one or more questions.

In an example, if the assessment parameter corresponds to seriousness for task, the one or more response features may include, but is not limited to, body language, dress, background, eye contact and the like. In another example, if the assessment parameter corresponds to user centric approach, or integrity, the one or more response features may include, but is not limited to, understanding of users, user empathy, usability testing, ethical decision-making, handling mistakes, honesty and transparency, critical thinking skills, collaboration and teamwork, and the like. In yet another example, if the assessment parameter corresponds to enthusiasm or motivational fit, the one or more response features may include, but is not limited to, engaged posture, gestures, baseline behaviour, consistency, professionalism, and the like.

In an example, if the assessment parameter corresponds to compatibility, communication, competence or cultural fit, the one or more response features may include, but is not limited to, consistency across criteria, holistic evaluation, behavioural indicators, diversity and inclusion, team fit, values alignment and the like. In another example, if the assessment parameter corresponds to attitude or adaptability, the one or more response features may include, but is not limited to, positivity, resilience, openness to feedback, flexibility, handling ambiguity, change management, creativity in problem solving, team collaboration in different settings, initiative in learning new skills and the like. In yet another example, if the assessment parameter corresponds to friendliness or future vision, the one or more response features may include, but is not limited to, long-term goals, industry trends and knowledge, commitment to learning, innovation and creativity, company fit, adaptability, question on future role, scenario-based questions, personal interests, past interactions, and the like.

At 404, response data may be retrieved. In an embodiment, the system 102 may be configured to retrieve the response data of the candidate associated with the assessment data. In an example, the system 102 may be configured to retrieve the response data using the user device 106. The database 314 may be further configured to store the response data. The response data refers to the response of the candidate to the one or more questions during the virtual interaction.

In an embodiment, the response data further comprises at least one of: user input data, video data, and audio data, as described in FIG. 3A. The response data may further comprise one or more response segments corresponding to the one or more questions. The response segment may refer to a portion of the response data corresponding to a given question which is to be analyzed.

In an embodiment the system 102 may be further configured to analyze, using the trained AI model 110, each of the one or more response segments based on the corresponding response features. Such an analysis may include, but is not limited to facial analysis, audio analysis, and text analysis based on the type of the response data. For example, if the response data is video data, the response segment may correspond to a sequence of video frames, and audio portion corresponding to each video frame. In such a scenario, the AI model 110 may be configured to analyze facial features in the sequence of video frames, and corresponding audio features. In an example, the facial analysis may include, but is not limited to smile and facial expression, eye contact, openness, micro expression, nodding and head movements, touching the face, facial relaxedness, and the like. In another example, the audio analysis may include, but is not limited to clarity and enunciation, tone of voice, pace of speech, listening skills, use of filler, confidence in responses, volume control, grammar and language proficiency, response time, and the like.

Further, the system 102 may generate, using AI model 110, a transcript for the audio portion corresponding to each video frame using speech to text techniques. In such an example, the text analysis may include, but is not limited to content alignment, structure of responses, relevance to questions, quantifiable achievements, critical thinking skills, use of keywords, self-awareness, and the like.

At 406, a score may be generated. In an embodiment, the system 102 may be configured to generate, using the trained AI model 110, the score for the response data based on the assessment data. In an embodiment the system 102 is further configured to analyze, using the AI model 110, each of the one or more response segments based on the corresponding response features. The system 102 is further configured to generate, using the AI model 110, a segment score for each of the one or more response segments based on the analysis. Thereafter, the system 102 is further configured to generate, using the trained AI model, the score for the response data based on the segment score for each of the one or more response segments. In an example, the system 102 may analyze the response data to generate the score. Such an analysis may include, but is not limited to facial analysis, audio analysis, and text analysis. The segment score may refer to score calculated for each category (such as, but not limited to, facial sentiment score, audio sentiment score, and text analysis score)

In an example, the AI model 110 may be trained to analyze the retrieved response data in the form of video data, text data or audio data to generate a score comprising at least one of a facial sentiment score, an audio sentiment score, or text analysis score.

In an example, the system 102 may retrieve the video response data. Further, the trained AI model 110 may employ a pre trained deep learning model for example, including but not limited to OpenCV or Dlib to detect and analyze facial expression in the video data during virtual interaction. The AI model 110 may be employed to extract facial landmarks from each frame of the video data. Such facial landmarks include for example, not limited to facial expressions, head movements, eye movements, eyebrow positions, mouth shape, and the like. Thereafter, the system 102 may estimate, using the AI model 110, an emotional state of the candidate based on the extracted facial feature and generate the facial sentiment score associated therewith. For example, a happy emotional state may indicate addition of 2 marks, a sad emotional state may indicate subtraction of 1 mark, an angry emotional state may indicate subtraction of 2 marks and a neutral state may indicate addition of 0 marks. The system 102 may be further configured to aggregate emotional data over the entire virtual interaction to calculate the facial sentiment score associated with emotional expressions of the candidate. In an example, the facial sentiment score may be calculated using the following formula:

facial sentiment score=number of happy emotions*(2)+number of sad emotions*(−1)+number of angry emotions*(−2)+number of neutral emotions*(0)

In another example, the system 102 may retrieve the audio response data. Further, the trained AI model 110 may employ audio processing libraries for example, but not limited to Librosa or deep learning models to detect and analyze emotional cues from the candidate's voice expression during virtual interaction. The AI model 110 may be employed to detect audio parameters associated with the audio data. Such audio parameters include for example, but not limited to clarity and enunciation, tone of voice, pitch of speech, volume control, listening skills, and other audio features to detect emotions. Thereafter, the system 102 may estimate, using the AI model 110, an emotional state of the candidate based on the detected audio parameters and generate the audio sentiment score associated therewith. For example, a confident tone may indicate addition of 2 marks, a nervous tone may indicate subtraction of 1 mark, a positive sentiment may indicate addition of 2 marks and a negative sentiment may indicate subtraction of 2 marks. The system 102 may be further configured to aggregate audio-based emotional data over the entire virtual interaction to calculate the audio sentiment score associated with voice expression of the candidate.

For example, if a candidate's video interview includes moments of smiling and laughter (positive facial sentiment), a confident and expressive tone in their voice (positive audio sentiment), and coherent and relevant responses in the transcription (positive text analysis) such positive factors may contribute to higher skill scores in their respective categories.

In an example, the system 102 may retrieve the text data. Further, the trained AI model 110 may employ automatic speech recognition system to transcribe the virtual interaction. The system 102 may be further configured to apply NLP techniques and machine learning models to analyze the transcription text for correctness, relevance, and communication skills. Thereafter, the system 102 generates the text analysis score based on the quality of the candidate's responses, content alignment, structure of response, grammar, language fluency, and the like. For example, the candidate may be asked to describe his experience till this date, the response of the candidate may be stored in a text format. Thereafter, the trained AI model 110 may employ NLP techniques like, but not limited to Keyword matching, Term Frequency-Inverse Document Frequency (TF-IDF), and Word Embedding, to calculate relevance of his response data based on the job description.

In an embodiment, the AI model 110 may utilize the said algorithms to match candidate skills with job description, thereby generating the initial score for the resume of the candidate. Thereafter, the system 102 may be configured to shortlist the resume of the candidate based on the initial score, as described in FIG. 3B.

In an embodiment, the system 102 is further configured to add the candidate to a list of shortlisted candidates based on the score of the response data 204b and the initial score. In an example, the system 102 may be further configured to generate an aggregate score based on the score of the response data and the initial score. For example, a score of the response data may be generated based on a weight for facial sentiment score is set to 40%, audio sentiment score is set to 20%, text analysis score is set to 20%, and an initial score is set to 20%. In such a scenario, the score for the response data may be an aggregate score calculated for each category and the assigned weights to each category. For example, if facial sentiment is 85/100, audio sentiment is 70/100, text analysis is 90/100, and the initial score is 80/100, the aggregate score may be calculated as (0.4*85)+(0.2*70)+(0.2*90)+(0.2*80)=82.

In another example, a score of the response data may be generated based on a weight for communication skill is set to 40%, problem solving skill is set to 30%, and adaptability is set to 30%. In such a scenario, the score for the response data may be aggregate score for calculated for each skill and the assigned weights to each category. For example, if communication score is 15/50, audio sentiment is 20/50, and text analysis is 10/50, the score for the response data may be calculated as (0.4*15)+(0.3*20)+(0.3*10)=15.

In another example, a score of the response data may be generated based on accuracy of the response. For example, a correct response may indicate addition of 10 marks, a partially correct response may indicate addition of 5 mark, and an incorrect response indicate 0 marks for a given 10 marks question.

In yet another example, a score of the response data may correspond to difficulty of the question associated therewith. For example, an easy question such as “What is a key component of effective communication” may have a lower score as compared to a difficult question such as “How have you adapted to unexpected changes in a project?”.

In an embodiment, the system 102 may be configured to assign a weight to each category based on the importance of each category for the given job description. In an example, such importance may be decided by hiring manager or a professional. In another example, AI model 110 may be trained to determine the importance of each category for the given job description. In such an example, the AI model 110 may be trained to dynamically determine the weight of each category based on the importance of each category for the given job description and assessment data. The AI model may be further trained based on specific interview questions, candidate responses, and the expected range of responses.

At 408 user input may be obtained. In an embodiment, the system 102 may be configured to obtain user input based at least on the score of the response data. For example, the hiring manager or a professional may analyze the score of the shortlisted candidates, and resume of the candidates, thereby deciding inconsistency between the generated scores. Such analysis may be helpful for the hiring manager or professional to determine whether or not a deserving candidate is assessed incorrectly due to the assigned weightage score 314c for the plurality of assessment data. To remove such inconsistencies, the system 102 may receive the user input indicative of the updated weightage score 314c associated with at least one of the plurality of assessment parameters 314b.

At 410, weightage score 314c may be updated. In an embodiment, the system 102 may be configured to update the weightage score 314c associated with at least one of the plurality of assessment parameters 314b based on the user input. Further, the AI model 110 may be re-trained based on the updated weightage score. In an embodiment, the system 102 may be further configured to generate the updated score for the response data based on the updated weightage score. In an example, the system 102 may be configured to obtain the user input based on the list of the shortlisted candidates and the resume of the candidate, as described in FIG. 3B. Additionally, AI model 110 may be configured to update the initial score based on the updated weightage score.

In an example, the system 102 may receive feedback on candidates who were hired and rejected based on the generated score. Thereafter, the system 102 may analyze, using the AI model 110, the feedback to identify areas where the AI model 110 might have misjudged candidates. Based on the analysis, the system 102 may update the assessment data based on the feedback analysis, to align with hiring manager preferences. For example, if hiring managers consistently provide feedback that the system 102 undervalues candidates with strong critical thinking skills, in such a scenario, the system 102 may obtain user input indicative of the updated assessment data. For example, adjust the AI model 110 to give more weight to a given attribute in the scoring process. Such continuous feedback may optimize and retrain the AI model 110 and adjust the scoring algorithm for better accuracy. Additionally, this allows flexibility to update weightage score 314c over time as the AI model learns from hiring decisions and feedback.

Further, the AI model 110 may help mitigate unconscious bias by ensuring that scoring is based on objective criteria. As the AI model does not have inherent biases or preferences, it evaluates candidates objectively based on data, thereby introducing no biases related to gender, age, or ethnicity. Additionally, an audit of the AI model may be performed in order to update the model and prevent any potential bias from emerging.

The disclosed system 102 may allow to assess the candidates by using real-world decision-making scenarios encountered by professionals in leadership roles. For example, the one or more questions may be relevant to the candidate's industry or job role, figuring complex issues and critical decisions for scenarios such as managing product recalls, PR crises, or resource allocation during financial challenges. In an example, each question may a multiple decisions points (options), each choice may have potential consequences, thereby enhancing complexity, demanding critical thinking and strategic decision-making skills from candidates. Further, the system 102 may leverage the use of AI model 110 to provide real-time feedback coupled with emotion analysis and nuanced evaluation of both verbal and non-verbal cues, thereby optimizing the candidate assessment process. Additionally, the system 102 may provide dynamic scoring based on the AI analysis, thereby ensuring continuous improvement and optimizing candidate shortlisting, and mitigating bias.

FIG. 5 illustrates a flowchart for implementation of a method for assessing skills of candidate through virtual interaction, in accordance with an embodiment of the present disclosure. FIG. 5 is explained in conjunction with elements of FIG. 1, FIG. 2, FIG. 3 and FIG. 4. With reference to FIG. 5, there is shown a flowchart 500. The operations of the exemplary method may be executed by any computing system, for example, by the system 102 of FIG. 1 or the processor 202 of FIG. 2. The operations of the flowchart 500 may start at 502.

At 502, assessment data is retrieved. In an embodiment, the system 102 is configured to retrieve the assessment data. The assessment data may comprise at least one of: a plurality of assessment parameters 314b, and a weightage score 314c associated with each of the plurality of assessment parameters 314b. The assessment data further comprises one or more questions and corresponding one or more response features associated with each of the plurality of assessment parameters 314b. Details about the retrieving of the assessment data are provided, for example, in FIG. 4.

At 504, response data is retrieved. In an embodiment, the system 102 is configured to retrieve the response data of a candidate associated with the assessment data. The response data comprises one or more response segments corresponding to the one or more questions, and wherein the one or more response features comprises positive response features and negative response features for the corresponding one or more questions. Details about the retrieving of the response data are provided, for example, in FIG. 4.

At 506, a score for response data is generated. In an embodiment, the system 102 is configured to generate, using a trained AI model 110, a score for the response data 204b based on the assessment data. In an embodiment, the system 102 is further configured to train the AI model 110 based on the retrieved assessment data. Details about the generating the score are provided, for example, in FIG. 3, and FIG. 4.

At 508, user input is input. In an embodiment, the system 102 is configured to obtain user input based at least on the score of the response data.

At 510, the weightage score 314c is updated. In an embodiment, the system 102 is configured to update the weightage score 314c associated with at least one of the plurality of assessment parameters based on the user input. The AI model 110 is re-trained based on the updated weightage score. Details about the updating of the weightage score 314c are provided, for example, in FIG. 3, and FIG. 4. Control may pass to end.

Various embodiments of the disclosure may provide a non-transitory computer readable medium and/or storage medium having stored thereon, instructions executable by a machine and/or a computer to operate a system (e.g., the system 102) to assess skills of candidate through virtual interaction using AI model. The instructions may cause the machine and/or computer to perform operations that include retrieving assessment data. The assessment data comprises at least one of: a plurality of assessment parameters, and a weightage score associated with each of the plurality of assessment parameters. Further include retrieving response data of a candidate associated with the assessment data. Further include generating, using the trained AI model 110, a score for the response data based on the assessment data. Further include obtaining user input based at least on the score of the response data; and updating the weightage score associated with at least one of the plurality of assessment parameters based on the user input, wherein the AI model is re-trained based on the updated weightage score.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for assessing a virtual interaction, comprising:
one or more processors; and
a memory coupled to the one or more processors, the memory having stored therein instructions executable by the one or more processors to configure the system to:
retrieve assessment data, wherein the assessment data comprises at least one of: a plurality of assessment parameters, and a weightage score associated with each of the plurality of assessment parameters;
retrieve response data of a candidate associated with the assessment data;
generate, using a trained AI model, a score for the response data based on the assessment data;
obtain user input based at least on the score of the response data; and
update the weightage score associated with at least one of the plurality of assessment parameters based on the user input, wherein the AI model is re-trained based on the updated weightage score.

2. The system of claim 1, wherein the assessment data further comprises one or more questions and corresponding one or more response features associated with each of the plurality of assessment parameters.

3. The system of claim 2, wherein the response data comprises one or more response segments corresponding to the one or more questions, and wherein the one or more response features comprises positive response features and negative response features for the corresponding one or more questions.

4. The system of claim 3, wherein the one or more processors is further configured to:
analyze, using the trained AI model, each of the one or more response segments based on the corresponding response features;
generate, using the trained AI model, a segment score for each of the one or more response segments based on the analysis; and
generate, using the trained AI model, the score for the response data based on the segment score for each of the one or more response segments.

5. The system of claim 1, wherein the AI model is trained based on the retrieved assessment data.

6. The system of claim 1, wherein the one or more processors is further configured to:
retrieve a resume of the candidate;
analyze, using the trained AI model, the resume of the candidate to generate an initial score; and
shortlist the candidate for the virtual interaction based on the initial score.

7. The system of claim 6, wherein the one or more processors is further configured to add the candidate to a list of shortlisted candidates based on the score of the response data and the initial score.

8. The system of claim 7, wherein the one or more processors is further configured to obtain the user input based on the list of the shortlisted candidates and the resume of the candidate.

9. The system of claim 1, wherein the response data further comprises at least one of: user input data, video data, and audio data.

10. A method, comprising:
retrieving assessment data, wherein the assessment data comprises at least one of: a plurality of assessment parameters, and a weightage score associated with each of the plurality of assessment parameters;
retrieving response data of a candidate associated with the assessment data;
generating, using a trained AI model, a score for the response data based on the assessment data;
obtaining user input based at least on the score of the response data; and
updating the weightage score associated with at least one of the plurality of assessment parameters based on the user input, wherein the AI model is re-trained based on the updated weightage score.

11. The method of claim 10, wherein the assessment data further comprises one or more questions and corresponding one or more response features associated with each of the plurality of assessment parameters.

12. The method of claim 11, wherein the response data comprises one or more response segments corresponding to the one or more questions, and wherein the one or more response features comprises positive response features and negative response features for the corresponding one or more questions.

13. The method of claim 12, wherein the method further comprises:
analyzing, using the trained AI model, each of the one or more response segments based on the corresponding response features;
generating, using the trained AI model, a segment score for each of the one or more response segments based on the analysis; and
generating, using the trained AI model, the score for the response data based on the segment score for each of the one or more response segments.

14. The method of claim 10, wherein the AI model is trained based on the retrieved assessment data.

15. The method of claim 10, wherein the method further comprises:
retrieving a resume of the candidate;
analyzing, using the trained AI model, the resume of the candidate to generate an initial score; and
shortlisting the candidate for the virtual interaction based on the initial score.

16. The method of claim 15, wherein the method further comprises adding the candidate to a list of shortlisted candidates based on the score of the response data and the initial score.

17. The method of claim 16, wherein the method further comprises obtaining the user input based on the list of the shortlisted candidates and the resume of the candidate.

18. The method of claim 10, wherein the response data further comprises at least one of: user input data, video data, and audio data.

19. A computer programmable product comprising a non-transitory computer readable medium having stored thereon computer executable instructions, which when executed by one or more processors, cause the one or more processors to conduct operations, comprising:
retrieving assessment data, wherein the assessment data comprises at least one of:
a plurality of assessment parameters, and a weightage score associated with each of the plurality of assessment parameters;
retrieving response data of a candidate associated with the assessment data;
generating, using a trained AI model, a score for the response data based on the assessment data;
obtaining user input based at least on the score of the response data; and
updating the weightage score associated with at least one of the plurality of assessment parameters based on the user input, wherein the AI model is re-trained based on the updated weightage score.

20. The computer programmable product of claim 19, wherein the assessment data further comprises one or more questions and corresponding one or more response features associated with each of the plurality of assessment parameters.
